(19) United States
(12) Patent Application Publication
(10) Pub. No.: US 2025/0208058 A1
(43) Pub. Date: Jun. 26, 2025

(54) BIOLOGICAL SAMPLE ANALYZER CALIBRATION AND CONTROL

(71) Applicant: Beckman Coulter, Inc., Brea, CA (US)

(72) Inventors: Jose Chacon, Pembroke Pines, FL (US); Vinay Prathapan, Miami, FL (US)

(21) Appl. No.: 18/985,938

(22) Filed: Dec. 18, 2024

Related U.S. Application Data
(60) Provisional application No. 63/614,240, filed on Dec. 22, 2023.

(51) Int. Cl. G01N 21/93; G01N 21/88

(52) U.S. Cl. CPC G01N 21/93; G01N 21/8851; G01N 2021/8893

(57) ABSTRACT

According to embodiment, a system for assessing a biological analyzer includes: a flowcell; a projection region; a media source configured to project media onto the projection region, wherein the media includes a representation of at least one particle within the flowcell; an imaging device aligned with the projection region, wherein the imaging device is configured to capture at least one image of the representation of the at least one particle; and a processor configured to process the at least one image of the representation of the at least one particle to assess a function of the biological analyzer.

### CROSS REFERENCE TO RELATED APPLICATIONS

This application claims the benefit of U.S. Prov. No. 63/614,240, filed on Dec. 22, 2023, the entirety of which is incorporated by reference, herein.

### BACKGROUND

Generally, this application relates to instruments/analyzers used for biological analysis incorporating imaging (hereinafter, biological analyzers). In some examples, the biological analyzers analyze biological particles, including biological cellular material, such as particles or cells in blood or urine.

A biological analyzer may be a relatively sensitive instrument, and may need to be assessed periodically to ensure it is functioning correctly (e.g., counting or recognizing particles correctly) through a control procedure. This control procedure is performed using control samples (or verification samples). Such control (or verification) samples may include known concentrations of one or more cells and/or particles (hereinafter, particles). A set of control samples may have different concentrations of particles in corresponding ones of the samples in the set. For example, a set of control samples may have three samples, each with different concentrations of a given type of particle. One example of control samples is Coulter Hematology 6C Cell Controls, which includes known concentrations of multiple particles. Because the concentrations of particles in the control samples is known a priori, the functionality and accuracy of a biological analyzer can be assessed by measuring the control samples and comparing the detected concentrations.

The control samples can be used to monitor the performance of biological analyzers in conjunction with specific reagents. They may be reference products prepared from stabilized human or animal blood. They may be prepared with known concentrations usable for counting, sizing, hemoglobin determination, NRBC enumeration, and/or white blood cell differentiation, for example, using VCS technology. For urine analysis, control samples may have fewer controls—e.g., only a red blood cell control.

Control samples, however, may be relatively expensive and relatively difficult to maintain. For example, control samples may be expensive to prepare. Further, control samples may need to be refrigerated, and thus a cold chain shipping network would be needed to preserve the control samples. Further, control samples have a limited shelf life. Further, regulations pertaining to shipping of blood (e.g., human blood) may increase expense and logistical efforts to distribute and obtain control samples.

There is therefore a need to have a biological analyzer with an improved control procedure.

### SUMMARY

According to embodiment, a system for assessing a biological analyzer includes: a flowcell; a projection region; a media source configured to project media onto the projection region, wherein the media includes a representation of at least one particle within the flowcell; an imaging device aligned with the projection region, wherein the imaging device is configured to capture at least one image of the representation of the at least one particle; and a processor configured to process the at least one image of the representation of the at least one particle to assess a function of the biological analyzer. The at least one media may include a static image. The at least one media may include a video. The at least one particle may include at least one of a red blood cell, a white blood cell, a crystal, a bacterium, or a platelet. The system may include at least one optical element configured to focus the at least one media on the projection region. The system may include at least one mirror configured to direct the media towards the projection region. The system may include a light source configured to cause additional light to be projected onto the projection region. The light source and the projection region and the media source may be arranged to project the light and the at least one media, respectively, onto the same side of the projection region. The light source may include an LED. The processor may be further configured to control a motor to cause an objective lens of the imaging device to move a predetermined distance along an optical axis after determining that the representation of the at least one particle is in focus. The optical axis may be substantially perpendicular to the projection region. The optical axis may be adjustable by the at least one motor to be substantially perpendicular to the projection region. The flowcell includes a viewing zone configured to receive fluid, and wherein the flowcell may be configured to not cause a fluid flow through the viewing zone while the imaging device captures the at least one image of the representation of the at least one particle. The objective lens may be oriented to receive light emitted from a first side of the projection region, and wherein the at least one media may be projected towards a second side of the projection region, wherein the second side of the projection region may be opposite the first side of the projection region. The at least one media may be focused at the first side of the projection region. The at least one media may be focused at the second side of the projection region. The first side of the projection region faces a viewing zone of the flowcell. The at least one media may be projected through a viewing zone of the flowcell. The media source and the projection region are maintained in a fixed relationship with each other. The system may be configured to adjust a focus of the at least one media on the projection region. The projection region includes a focus pattern, configured to assist with focusing of the imaging device. The media source may include a display. The display may include at least one of a digital micromirror device, a liquid-crystal-on-silicon device, or a liquid crystal display. The projected media has an area of between 90,000-490,000 μm² on the projection region. The at least one particle may include at least one of a red blood cell, a white blood cell, a crystal, a bacterium, or a platelet. The at least one particle may include a control particle. The control particle may be at least one of a red blood cell, a white blood cell, or a platelet. The at least one particle may include a calibration particle. The calibration particle may be latex. The processor may be further configured to automatically adjust an operation of the biological analyzer based on the assessed function of the biological analyzer. The adjusted operation may include at least one of adjusting an optical parameter, adjusting a position of the imaging device, adjusting a flowrate of fluid through the flowcell, adjusting an electronic parameter for the media source, or adjusting an electronic parameter for the imaging device. The at least one particle may include a plurality of particles simulating a concentration for a given type of particle, and wherein the assessed function of the biological analyzer includes determining the concentration from the images of the plurality of particles. The at least one particle may include a plurality of particles simulating a plurality of concentrations for a corresponding plurality of types of particle, and wherein the assessed function of the biological analyzer includes determining the plurality of concentrations from the images of the plurality of particles. The media includes video having a plurality of frames, wherein the plurality of frames includes a first set of frames and a second set of frames, wherein the first set of frames includes representations of a first group of particles simulating a first concentration for a given type of particle, wherein the second set of frames includes representations of a second group of particles simulating a second concentration for the given concentration, and wherein the assessed function of the biological analyzer includes determining the first concentration for the given type of particle and the second concentration for the given type of particle from the images of the plurality of particles. The media includes video having a plurality of frames, wherein the plurality of frames includes a first set of frames and a second set of frames, wherein the first set of frames includes representations of a first group of particles simulating a first plurality of concentrations for corresponding types of particles, wherein the second set of frames includes representations of a second group of particles simulating a second plurality of concentrations for the corresponding types of particles, and wherein the assessed function of the biological analyzer includes determining the first plurality of concentrations and the second plurality of concentrations. The biological analyzer may include a blood analyzer. The at least one particle may include at least one of a red blood cell, a white blood cell, a crystal, a bacterium, or a platelet. The at least one particle may include a control particle. The control particle may be at least one of a red blood cell, a white blood cell, or a platelet. The at least one particle may include a calibration particle. The calibration particle may include latex. The biological analyzer may include a urine analyzer. The at least one particle may include a red blood cell. The at least one particle may include a control particle. The control particle may be at least one of a red blood cell, a white blood cell, or a platelet. The at least one particle may include a calibration particle. The calibration particle may include latex.

### BRIEF DESCRIPTION OF SEVERAL VIEWS OF THE DRAWINGS

FIG. 1 is a schematic illustration, partly in section and not to scale, showing operational aspects of an exemplary flowcell and associated components, which may be used in a biological analyzer configured to capture and analyze images.

FIG. 2 is a block diagram of a portion of a biological analyzer, according to embodiments.

FIG. 3 is a block diagram of a media source and associated components for projecting media onto a projection region, according to embodiments.

FIGS. 4A and 4B are block diagrams showing adjustment in operation of a biological analyzer during an assessment phase (FIG. 4A) and an operation phase (FIG. 4B), according to embodiments.

FIG. 5 is a flowchart for a method for assessing a function of a biological analyzer, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

Techniques disclosed herein are applicable to analysis of a variety of types of samples. For example, the disclosed techniques may be applicable to blood analysis or urine analysis. Although blood analysis is primarily disclosed herein, it is just an example embodiment, and the disclosed techniques could be applicable to analysis of other types of particles, besides particles found in blood (e.g., particles found in urine). Techniques disclosed herein allow for assessing and adjusting the functionality of such an instrument without having to use real control samples or real calibration samples. Instead, virtual samples can be used, which are media with representations of particles. The instrument detects these virtual particles and the functionality of the instrument is assessed based on the results of detection.

The terms control sample, control particle, calibration sample, and calibration particle may be terms used herein. Control particle refers to one or more particles used to assess whether an analyzer is functioning correctly (e.g., reading or registering analyzed cells correctly). Control sample refers to one or more samples of control particle material (e.g., a tube of control particle material). Calibration particle refers to one or more particles used to calibrate an analyzer, for example as part of a process to adjust optical parameters of the analyzer that the analyzer uses to read or register analyzed cells. Calibration sample refers to one or more sample of calibration particle material (e.g., a tube of calibration particle material). For the purposes herein, these terms can be used interchangeably to refer to particle(s)/sample(s) used to assess the functionality of an analyzer.

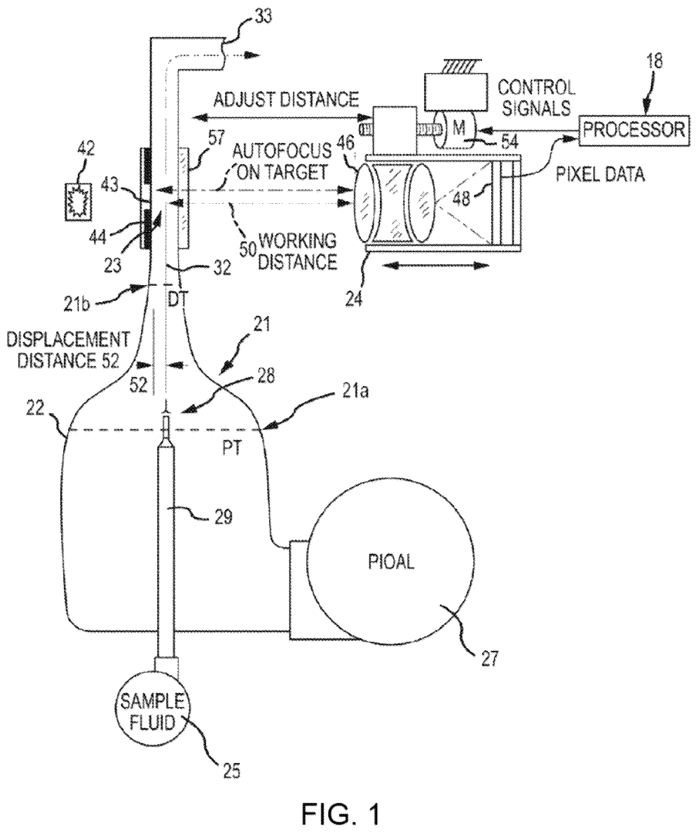

FIG. 1 schematically illustrates a biological sample analyzer (or biological analyzer, or analyzer), and particularly a system utilizing flow imaging principles. Though this disclosure provides embodiments of a biological analyzer utilizing flow imaging, the techniques may be applicable to other types of biological analyzers, as will be understood (e.g., static or slide imaging). The system of FIG. 1 includes an exemplary flowcell 22, which may be used in the analyzer for conveying a sample fluid through a viewing zone 23 of an optical imaging device 24 (e.g., a camera and/or associated optics) in a configuration for imaging microscopic particles in a sample flow stream 32 using digital image processing. Flowcell 22 may be coupled to a source 25 of sample fluid, which may have been previously processed, such as through contact with a particle contrast agent composition and heating/incubation. Flowcell 22 may also be coupled to one or more sources 27 of a sheath fluid, such as a clear glycerol solution having a viscosity that is greater than the viscosity of the sample fluid, an example of which is disclosed in U.S. Pat. Nos. 9,316,635 and 10,451,612, the disclosures of which are herein incorporated by reference in their entireties. For the purposes of terminology, a sheath fluid is traditionally used to envelope a sample stream for analysis not involved imaging, for instance in circumstances where a sample is surrounded by sheath and subject to laser or light excitation to determine a fluorescence or light scatter property. In the context of this application, particle and/or intracellular organelle alignment liquid (PIAOL) is a type of sheath fluid customized for imaging applications, that is in the context of FIG. 1 where a sample (e.g., blood sample) is surrounded by a sheath fluid through an imaging region of a flowcell 22. A sheath fluid used for urine applications sold under the trade name Lamina or iQ Lamina is another type of sheath fluid that can be used for these purposes. The terms sheath, sheath fluid, PIAOL, and Lamina may be used interchangeably for the purposes of this application.

The sample fluid may be injected through an opening (e.g., flattened opening) at a distal end 28 of a sample feed tube 29, and into at a point in the interior of the flowcell 22 where the sheath fluid flow may be substantially established, resulting in a stable and symmetric laminar flow of the sheath fluid above and below (or on opposing sides of) a sample stream (e.g., ribbon-shaped). The sample stream and sheath fluid stream may be forced by metering pumps (not shown) that move the sheath fluid with the sample fluid along a flowpath that narrows. The sheath fluid envelopes and compresses the sample fluid in zone 21 (e.g., a narrowing zone) where the flowpath narrows. The decrease in flowpath thickness in zone 21 can contribute to a geometric focusing of a sample flow stream 32. The sample flow stream 32 may be enveloped by the sheath fluid and conveyed downstream from zone 21, passing in front of, or otherwise through viewing zone 23 of, an optical imaging device 24 where images are obtained, for example, using an image sensor 48, such as a CCD. The sample flow stream 32 may flow through a channel. Processor 18 may receive data from image sensor 48. Processor 18 may include one or more processors. Processor 18 may control the operation of flowcell 22 and/or optical imaging device 24. Data from image sensor 48 (e.g., images) may be stored in a memory (e.g., non-volatile memory). Processor 18 may process data from image sensor 48, for example, by retrieving image data from memory. Processor 18 may execute instructions stored on a memory (which may or may not be the same memory in which image data is stored). The executed instructions may cause processor 18 to function as described herein. The sample flow stream 32 flows together with the sheath fluid to a discharge 33.

As shown here, zone 21 can have a proximal flowpath portion 21a having a proximal thickness PT and a distal flowpath portion 21b having a distal thickness DT, such that distal thickness DT is less than proximal thickness PT. The sample fluid can therefore be forced through the distal end 28 of sample tube 29 at a location that is distal to the proximal portion 21a. Hence, the sample fluid can enter the sheath fluid envelope as the sheath fluid stream is compressed by the zone 21, wherein the sample tube 29 has an exit port through which sample fluid is injected into flowing sheath fluid, the exit port bounded by a narrowing region of zone 21.

The optical imaging device 24 with objective lens 46 is directed along an optical axis that intersects the sample flow stream 32. The relative distance between the objective lens 46 and the sample flow stream 32 is variable by operation of a motor drive 54 coupled (e.g., indirectly coupled as depicted) to the objective lens 46. The objective lens 46 can be repositioned to focus an image onto image sensor 48.

FIG. 1 further illustrates a light source 42, which may illuminate sample stream 32 during imaging. According to some embodiments, an autofocus pattern 44 can have a position that is fixed relative to the flowcell 22, and that is located at a displacement distance from the plane of the sample stream 32. In the embodiment shown, the autofocus pattern 44 is applied directly to the flowcell 22 at a location that is visible in an image collected through viewport 57 by optical imaging device 24. The autofocus pattern 44 can be used to set a correct focal location of the objective lens relative to the flowcell 22, for instance by setting a location where the autofocus pattern 44 is in its ideal focal state. In additional or alternative configurations, imaging processing of the biological material being imaged (e.g., blood cells) can be used to determine a focal position, for instance utilizing pixel analysis of the blood cells. Information on autofocusing or focal quality assessment can be found in U.S. Pat. Nos. 9,857,361, 10,794,900, 10,705,008, 11,543,340, 10,705,11, the disclosures of which are hereby incorporated by reference in their entireties.

Additional embodiments regarding the construction and operation of flowcells (e.g., flowcell 22) and optical imaging devices (e.g., optical imaging device 24) are disclosed in U.S. Pat. No. 9,322,752, entitled “Flowcell Systems and Methods for Particle Analysis in Blood Samples,” filed on Mar. 17, 2014, which is herein incorporated by reference in its entirety. Embodiments disclosed below may be described in the context of the analysis system shown in FIG. 1, but are not limited to such a system.

A biological sample analyzer, such as the one shown in FIG. 1 and utilizing flow cell 22 and optical imaging device 24, may acquire and analyze a number of images of a sample. The sample may include various types of particles, such as an erythrocyte, a reticulocyte, a nucleated red blood cell, a platelet, or a white blood cell. The biological sample analyzer can determine quantity information for one or more types of particles in the sample. For example, the biological sample analyzer can determine quantity information for a first particle type and quantity information for a second particle type (or quantity information for additional particle types). Quantity information for a given type of particle may include an actual count, an estimated count, a concentration of the given type of particle in the sample, a number of images that include the given type of particle, or other types of assessment of the quantity of the given type of particle in the sample. This disclosure may refer to one type of quantity information (e.g., count), but it is understood that other types of quantity information (e.g., number of images that include a given particle type) may be used as well. For counts of each particle type, there is a corresponding concentration of the particle type in the sample. A given concentration can be determined by dividing the number of particles in the sample (e.g., a particle or cell count) by the volume of the sample. In order to determine the number of a given type of particle is present in a sample, the images of the sample may be analyzed by a processor (e.g., processor 18) to detect the given type of particle. Various computational approaches can be used to determine a particle type, for instance artificial intelligence or machine-learning based algorithms, pixel-based or feature-based analysis, image masking techniques, or other computational techniques. Information about such approaches can be found in U.S. Pat. Nos. 11,403,751, 6,947,586, 7,236,623, the disclosures of which are hereby incorporated by reference in their entireties.

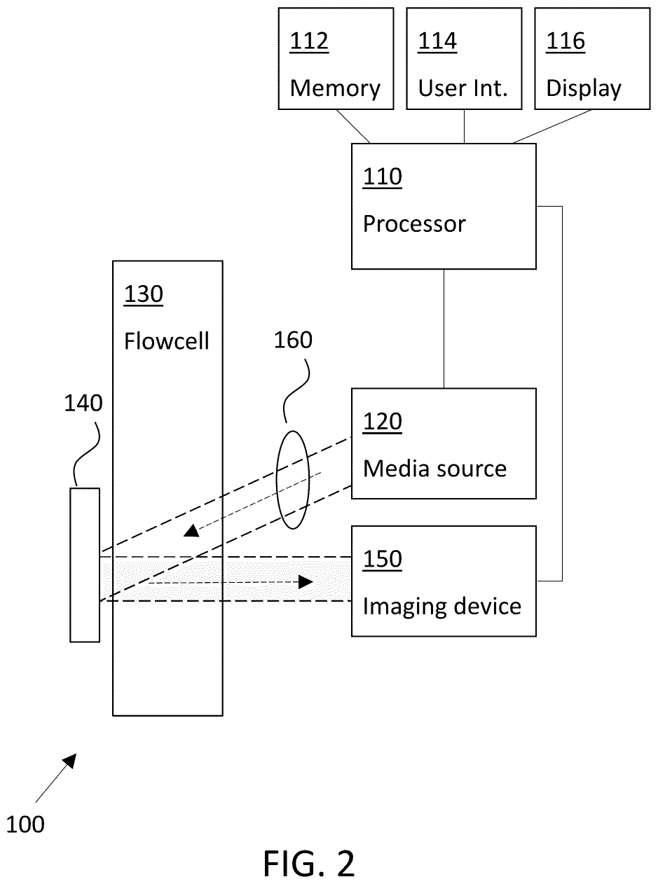

FIG. 2 is a block diagram representative of a portion of a biological analyzer 100. Included are processor 110 (and associated memory 112, user interface 114, and display 116), media source 120, flowcell 130, projection region 140, and imaging device 150. Biological analyzer 100 may be similar in certain aspects to the biological analyzer shown in FIG. 1. For example, processor 110 may be similar to processor 18, imaging device 150 may be similar to optical imaging device 24, and flowcell 130 may be similar to flowcell 22. These components may function in similar ways.

Processor 110 may control some or all aspects of biological analyzer 100. Processor 110 may be a single processor, or a plurality of processors. In the case that processor 110 is a plurality of processors, they may be integrated in a single chip (e.g., ASIC), or they may be distributed at different locations (e.g., multiple processors in a single instrument, multiple instruments where one is running a sample and another is analyzing results, or a cloud environment). Multiple processors in processor 110 may communicate with each other. Processor 110 may execute a set of instructions stored in associated memory 112 to effect the functions described herein as they pertain to processor 110. Processor 110 may receive inputs from one or more user interface components 114 (e.g., mouse, keyboard, touch pad, etc.), thereby allowing a user to interact with processor 110. A user may be able to view various operational parameters such as the ones described herein, or cause processor 110 to take actions (e.g., operate biological analyzer 100 in one or more of the various manners described herein). Processor 110 may interact with display 116 to cause operational details (e.g., parameters and/or system status) to be displayed to a user.

Processor 110 may communicate with or control imaging device 150. Processor 110 may receive image data from imaging device 150 (which may include an image sensor, similar to image sensor 48, that converts received energy into electrical charge). Processor 110 may also control imaging device 150. For example, imaging device 150 may have or be associated with translation componentry (e.g., like motor dive 54), which may move imaging device 150 along one or more dimensions. For example, processor 110 may control such translation componentry to move imaging device 150 towards or away from flowcell 130 and projection region 140.

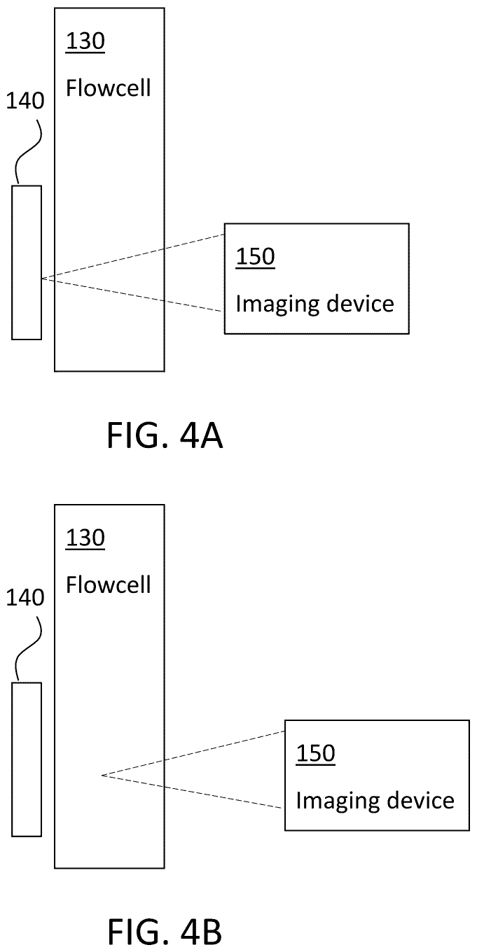

Imaging device 150 may include optical elements, such as those described with respect to FIG. 1 and optical imaging device 24. Such optical elements may include an objective lens, such as objective lens 46. Imaging device 150 may be substantially aligned with projection region 140, and specifically, substantially aligned with a desired projection area on the projection region 140 where media from media source 120 is projected. Imaging device 150 may define an optical axis, and this axis may be substantially perpendicular to projection region 140 or the projection area where the media is projected. Imaging device 150 may be adjustable (e.g., by processor 110 using translation or rotation motors or devices) to cause the optical axis to be substantially perpendicular to projection region 140 of the projection area where the media is projected. Imaging device 150 may have an adjustable focal length and/or ability to focus on subject matter at different locations (for example, by moving the objective lens and/or image sensor with translation componentry). Once focused, the projected media may have an area on projection region 140 of about 90,000-490,000 μm² (e.g., about 150,000-400,000 μm², or about 300,000-400,000 μm², or about 384,384 μm²). A height of the projection area may be between approximately 300-700 μm (e.g., about 572 μm). A width of the projection area may be between approximately 300-700 μm (e.g., approximately 672 μm). The projection area may be a square, rectangle, circular, ovular, or some other shape. In one embodiment, the projection area is a square, and the height of the projection area is approximately 300 μm and the width of the projection area is approximately 300 μm, resulting in an area of approximately 90,000 μm². In another embodiment where the projection area is a square, the height of the projection area is approximately 700 μm and the width of the projection area is approximately 700 μm, resulting in an area of approximately 490,000 μm². In another embodiment, the height of the projection area is approximately 572 μm and the width of the projection area is approximately 672 μm (or vice versa), resulting in an area of approximately 384,384 μm². Imaging device 150 may have a depth of field between approximately 1-5 μm (e.g., about 4 μm to 5 μm). Imaging device 150 may capture images in a viewing zone (e.g., viewing zone 23). Imaging device 150 may capture images through a viewport (e.g., viewport 57). FIGS. 4A and 4B illustrate how imaging device 150 may be adjusted to focus on subject matter at different locations.

Turning back to FIG. 2, flowcell 130 may be similar to flowcell 22. In accordance with embodiments, biological analyzer 100 may operate during a calibration or control phase while no sample flows through flowcell 130, although there still may be fluid in flowcell 130. Light may be transmitted through flowcell 130 (e.g., light projected from media source 120 or light reflected by projection area 140.

Media source 120 may project media onto projection region 140. Media source 120 may be a microdisplay, such as a transparent or translucent microdisplay. Examples of media source 120 include a digital micromirror device, a liquid-crystal-on-silicon device, or a liquid crystal display. A digital micromirror device may include microscopic mirrors arranged in an array (e.g., a rectangular grid pattern) with micromechanical elements to control the orientation of each mirror element to reflect a conditioned source of light selectively, to mimic each pixel in the image being projected, to a targeted area. A liquid-crystal-on-silicon device may include a microarray of active-matrix liquid-crystal pixel elements on a silicon backplane, with the ability to selectively turn each pixel light or dark (or transition between these two states) to allow a conditioned light source impinging on the surface of the device to reflect off of it with the pixel information incorporated into the reflection, which then can be collimated to project the resulting image onto a surface. For color images, the image data may need to be separated into its primary colors and the source light modulated in time or space to produce a re-combined color image. A liquid crystal display may include a conditioned light source with a sandwich of polarizing filters (interspaced by a polarization modulating “liquid crystal” layer and an electrode array layer), to selectively turn pixels opaque or transparent (or in-between states) to replicate pixels of a grayscale image. Media source 120 may include optics, such as a focusing lens, or optics may be external to media source 120, such as focusing lens 160. Media source 120 may be offset from imaging device 150, or may be substantially aligned with imaging device 150. Media source 120 may be on the side of projection region 140 as shown, or on the opposite side of projection region 140 (i.e., opposite of projection region 140 with respect to imaging device 150). In FIG. 2, the broken-line arrows show the direction of light in biological analyzer 100 from media source 120 to imaging device 150. Media source 120 may project media onto projection region 140, and such media will further be explained. Media source 120 may be adjusted (either internal adjustment or movement of media source 120) to focus the media onto projection region 140, and a particular projection area on projection region 140. Media source 120 may project media through a viewport (e.g., viewport 57). Media source 120 may be adjusted to focus media in coordination with imaging device 150 and processor 110. For example, imaging device 150 can obtain images of the projected media on projection region 140 and processor 110 can determine whether those images are substantially in focus. If not, processor 110 can adjust media source 120 to cause the media to be substantially focused on projection region 140.

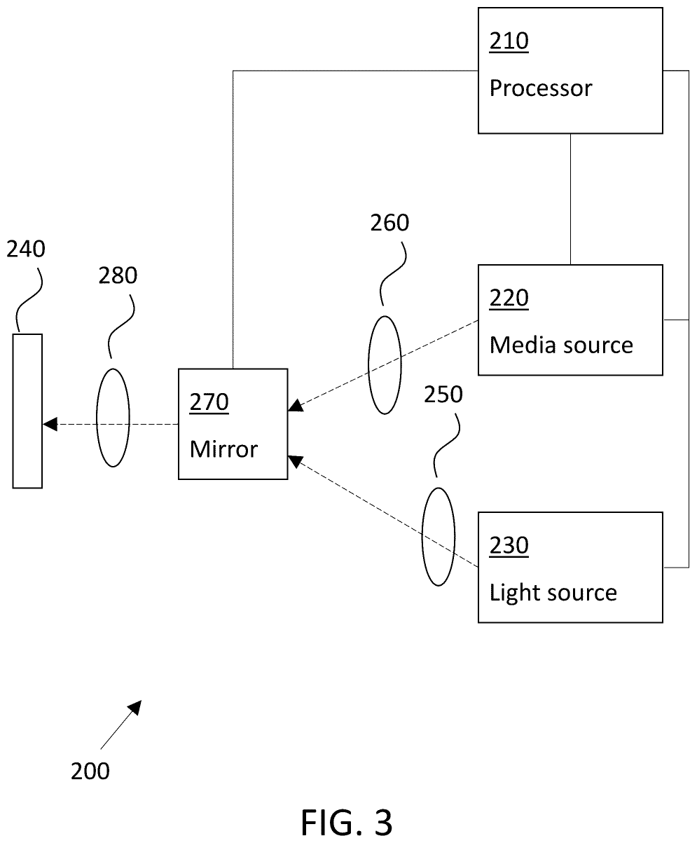

Turning to FIG. 3, an alternative arrangement 200 for projecting media is shown. Processor 210 may be similar to processor 110. Media source 220 may be similar to media source 120. Focusing optics 260 may be similar to focusing optics 160. Projection region 240 may be similar to projection region 140. Also included are light source 230, light source focusing optics 250, mirror 270, and mirror focusing optics 280. Light source 230 may be capable of providing a relatively optically uniform background to the pixel data modulated by the micromirror or LCD device. Depending on whether the images to be projected are produced by reflecting light or by selective transmission of light at the pixel level, light source may be LED-based, arc-lamp based, or even filament-based. Light source 230 may be controlled (e.g., switched ON/OFF, dimmed, strobed, moved, etc.) by processor 210. Light source 230 may be optional. Focusing optics 250 may focus light source onto mirror 270.

Mirror 270 may be similar to a digital micromirror device described above in context of media source 120. Mirror 270 may have an adjustable position (e.g., an adjustable angle or translated position). Processor 210 may control the operation of mirror 270, including adjusting the angle of mirror 270. Such an angle can be adjusted to position the projected media onto the desired location of projection region 240. Light (media) from media source 220 may be combined with light from light source 230 at mirror 270. This light may then be reflected by mirror 270 towards projection region 240. The reflected light may be further focused by focusing optics 280.

Turning back to FIG. 2, projection region 140 may abut or be inside of flowcell 130. Projection region 140 may be separated from flowcell 130. Projection region 140 may be proximate a viewing zone in flowcell 130 (e.g., viewing zone 23). Projection region 140 may be back-lit by a light source on the opposite side of projection region 140 from media source 120 (similar to light source 42). Projection region 140 may also be front-lit by a separate light source on the same side of projection region 140 as media source 120. Projection region 140 may not receive light aside from that provided by media source 120 during an assessment phase of operation of biological analyzer 100, as will be further explained. Projection region 140 may include a pattern that facilitates focusing of imaging device 150 and/or media source 120 (or associated optics). Processor 110 may determine how well the pattern is focused and adjust imaging device 150 to improve focusing, as helpful. Projection region 140 can be a portion of the flowcell 130 configured to receive the projection (e.g., a normal portion of the flowcell 130 that a sample would flow through for particle imaging). In this context, the projection region 140 can comprise the material of the flowcell 130, including a material such as glass, or polymers. Projection region 140 may be translucent, transparent, or opaque. Projection region may include a focus pattern (e.g., similar to autofocus pattern 44). The focus pattern may facilitate focusing or automatic focusing of imaging device 150 on projection region 140.

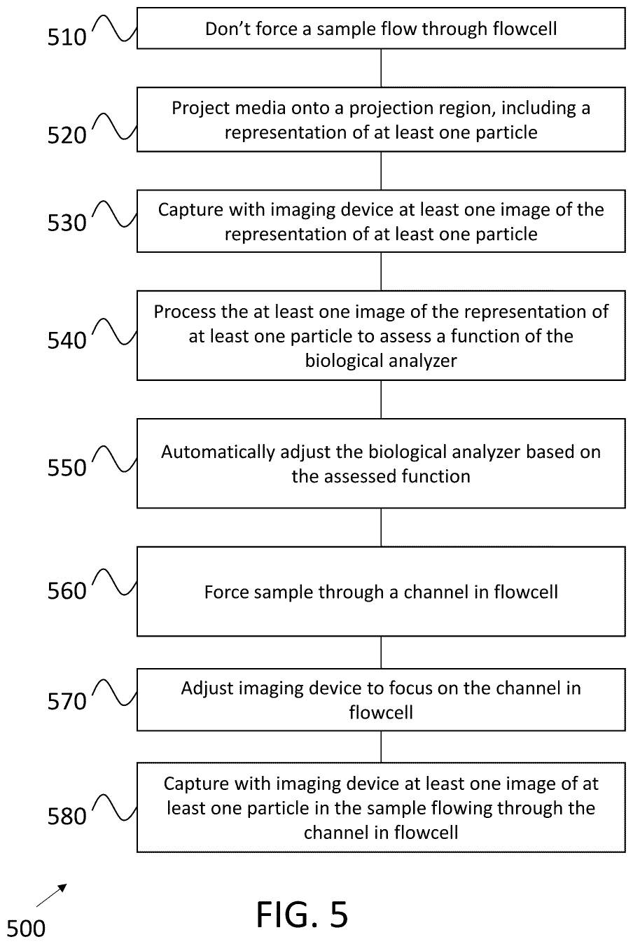

FIG. 5 is a flowchart 500 for a method for assessing a function of a biological analyzer, according to embodiments. The steps in flowchart 500 may be performed by a biological sample analyzer, such as the one shown in FIG. 2. The steps in flowchart 500 may be implemented by a computer. For example, the steps in flowchart 500 may be performed by a processor, such as processor 18, 110, 210. The steps may be performed when the processor executes instructions stored on a computer-readable memory (e.g., a non-transitory memory). The steps may be performed in sequence as shown, in a different sequence (e.g., step 570 may precede step 560), and/or some of the steps may be performed in parallel or may overlap in time (e.g., steps 560 and 570 are performed simultaneously or overlappingly). Some steps need not be performed, such as, for example, steps 510, 550, 560, 570, and/or 580. Flowchart 500 is described in conjunction with biological analyzer 100, but is not so limited.

At step 510, a sample is not forced through flowcell 130 in biological analyzer 100. There may be no flow if, for example, no sample has been provided to biological analyzer 100. The sample may not be forced if, for example, a pressure gradient is not established across which a fluid would flow. The flowcell 130 may still contain fluid, and may even contain a sample, but there is no flow. Step 510 is optional, and it is within the scope of this disclosure that a sample or fluid more generally can flow through flowcell 130 during any or all of the other steps.

At step 520, media is projected onto projection region 140 in a particular projection area. The media includes a representation of at least one particle. Such particles include one or more of a red blood cell (e.g., erythrocyte, reticulocyte, or nucleated red blood cell), white blood cell, crystal, bacterium, platelet, or the like. The representations may include particles that are not intended to be recognized or analyzed by biological analyzer 100. Examples of such extraneous particles include unclassified particles that do not fit any of the list of particles the system recognizes (e.g., recognized by a machine-learning model). The system may be able to account for such unclassified particles using, for example, a machine learning model. Training images used for the machine learning model may include unclassified particles, and the model may recognize them as unclassified as a result of training. The media may be a single image or a series of images displayed at a given frame rate. In the example that images are displayed in a series, the frame rate may correspond to a typical flow speed of a real sample through flowcell 130. The frame rate may be adjustable or may vary to correspond to different flow rates. Such rates may range from 0.5 μL/s to 4.0 μL/s. The particle representations may include one or more particles having possibly different sizes, shapes, or morphologies. For example, a urine crystal particle may be represented in one image at a first size/shape/morphology and a second image at a second size/shape/morphology. The entire set of images may represent an entire virtual sample. When images are sequenced, the particles may correspond to one or more predetermined concentrations in the virtual sample.

The virtual sample may be used to calibrate biological analyzer 100 during a calibration phase, which may be used to adjust a parameter of biological analyzer 100, thereby changing how biological analyzer 100 analyzes real or virtual particles and/or real or virtual samples. An example of a virtual sample is one with representations of red blood cells in the range of approximately 6 to 8 μm, at a concentration of about 1000 cells/microliter At step 530, imaging device 150 may capture the image(s) in the media. The projected images may reflect off of projection region 140 towards imaging device 150, where the reflected light is measured and converted into image data. Image data may include intensity information and/or color information. The image data may be transmitted to processor 110. Image data may be captured for one image in the media at a time. Once image data has been successfully captured, the media may be advanced to the next image. In another embodiment, the media runs continuously and imaging device 150 records the images continuously without any feedback. In such a case, imaging device 150 and media source 120 may be synchronized, such that the intent is for imaging device 150 to capture each image in the media. Imaging device 150 may optionally capture the images multiple times, thereby creating multiple image data sets. Media source 120 may change the intensity and/or color(s) of the projected media and/or background color (i.e., where there are no representations of particles in the media). Imaging device 150 may capture image data of a given image in variations of such conditions.

At step 540, processor 110 assesses the image data captured by imaging device 150. The image data may be stored in memory 112, and then retrieved for analysis by processor 110. Processor 110 may determine various aspects of the representation(s) of the particle(s), such as particle type, particle size, particle concentration (e.g., different concentrations corresponding to differently-sized particles), or other aspects of particles, such as opacity, degree of sharpness, sub-structure shapes, partial occlusions of particles, or the like.

Once this information has been organized, one or more functions of biological analyzer 100 may be assessed. Assessment may be during the calibration phase of biological analyzer 100 and/or the control phase of biological analyzer 100.

Assessment of function(s) during a calibration phase may be used to adjust a parameter of biological analyzer 100, thereby changing how biological analyzer 100 analyzes particles or a sample. For example, since a concentration of a given type of virtual particle in the virtual sample is known (e.g., a red blood cell in urine having a concentration of 30 cells/μL), this can be compared to the results of the computations by biological analyzer 100 on a real calibration sample. If there is a mismatch between the known concentration and the measured concentration (outside of an acceptable tolerance), then biological analyzer can be adjusted, as further discussed in step 550.

Assessment of function(s) during a control phase may be used to test whether biological analyzer 100 is functioning correctly. As with calibration, the detected concentration in a real control sample of a given particle (e.g., red blood cells in the control sample having a concentration of 1000 cells/μL) can be compared to the known concentration in the virtual sample. If there is a match of concentrations (within an acceptable tolerance), then biological analyzer 100 may be assessed to be operating correctly for a given function. If there is a mismatch, then a user may be alerted (e.g., on display 116). Alternatively, or in addition, biological analyzer 100 may automatically enter a calibration phase to attempt to get biological analyzer 100 functioning correctly. Such adjustment during calibration is further described in step 550.

At step 550, processor 110 automatically adjusts biological analyzer 100 based on the results of step 540. Step 550 may be optional. For example, step 550 may not be performed if the method is executed for a control phase (as opposed to calibration phase). Step 550 can include such adjustment steps as adjusting an optical parameter related to flowcell 130, adjusting a position of a camera relative to flowcell 130, adjusting a flowrate of fluid through flowcell 130, or adjustment of various electronic parameters (such as amplitudes, gains, etc.) that are part of an optical/visual system or flowcell 130.

At step 560, a real sample may be forced through a channel in flowcell 130 during an operational phase. The real sample may be forced while biological analyzer 100 has updated operation, as described in step 550 during a calibration phase.

At step 570, imaging device 150 may be adjusted to focus not on projection region 140, but on the flowing sample through the channel in flowcell 130. FIGS. 4A and 4B are block diagrams showing adjustment in operation of biological analyzer 100 during an assessment phase (FIG. 4A) and an operation phase (FIG. 4B). After assessment is complete, the focus distance of imaging device 150 may be moved away from projection region 140 to where the sample is flowing through flowcell 130. Such movement of imaging device 150 may be effected by processor 110, as previously described. Movement of the focal distance may be adjusted in other ways by modifying the arrangement of components internal to imaging device 150 without moving imaging device 150 entirely.

At step 580, imaging device 150 captures images of particles in the sample flowing through flowcell 130 as biological analyzer 100 typically operates during the operational phase. The captured image data is then processed by processor 110, and characteristics of the particle(s) in the sample are determined.

Additional embodiments can utilize a real control or calibration media for portion(s) of a control or calibration procedure, and virtual controls or calibration media for other portion(s) of a control or calibration procedure. For example, processes related to fluidics (such as testing fluidic parameters through flowcell 130) may be better tested by real control or calibration media (e.g., human or animal-derived blood cells, or synthetic beads) since this parameter is related to real fluidics flow. However, processes related to parameters besides fluidic parameters (e.g., one or more of particle count, particle concentration, optics, or autofocus) can be tested by virtual controls or calibration particles since these parameters are related to a camera position or a performance of a counting procedure. Therefore, some embodiments may utilize a combination or real control or calibration media, and virtual control or calibration media. Some embodiments may in turn utilize procedures utilizing both real control or calibration media, and virtual control or calibration media.

By way of example, where a real control or calibration media is used, this would commence a procedure unique to this real control or calibration media (e.g., as different from the normal blood or urine particle counting procedure for real biological sample). For example, a barcode scan of a sample can flag that sample as being particular to control or calibration media, and trigger a procedure, algorithm, or software code specific to this process or procedure (e.g., counting the real control or calibration media to assess if a correct count or concentration is observed). Where virtual control or calibration media is used, this can be part of a routine process run automatically by software, or be a process enabled by the user where the procedure commences, and the computing system executes a program to present virtual control or calibration media to imaging device 150 (e.g., to ensure a correct count or concentration is observed, or that a particular threshold of virtual cells are properly focused).

The operations described herein may be performed or effected using a computer or other processor (e.g., processor 110, 210, or 18) having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

All patents, patent publications, patent applications, journal articles, books, technical references, and the like discussed in the instant disclosure are incorporated herein by reference in their entirety for all purposes.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A system for assessing a biological analyzer, comprising:
a flowcell;
a projection region;
a media source configured to project media onto the projection region, wherein the media includes a representation of at least one particle within the flowcell;
an imaging device aligned with the projection region, wherein the imaging device is configured to capture at least one image of the representation of the at least one particle; and
a processor configured to process the at least one image of the representation of the at least one particle to assess a function of the biological analyzer.

2. The system of claim 1, wherein the processor is further configured to control a motor to cause an objective lens of the imaging device to move a predetermined distance along an optical axis after determining that the representation of the at least one particle is in focus.

3. The system of claim 1, wherein the flowcell includes a viewing zone configured to receive fluid, and wherein the flowcell is configured to not cause a fluid flow through the viewing zone while the imaging device captures the at least one image of the representation of the at least one particle.

4. The system of claim 1, wherein the at least one particle comprises a control particle.

5. The system of claim 1, wherein the at least one particle comprises a calibration particle.

6. The system of claim 1, wherein the processor is further configured to automatically adjust an operation of the biological analyzer based on the assessed function of the biological analyzer.

7. The system of claim 1, wherein the at least one particle comprises a plurality of particles simulating a concentration for a given type of particle, and wherein the assessed function of the biological analyzer includes determining the concentration from the images of the plurality of particles.

8. The system of claim 1, wherein the at least one particle comprises a plurality of particles simulating a plurality of concentrations for a corresponding plurality of types of particle, and wherein the assessed function of the biological analyzer includes determining the plurality of concentrations from the images of the plurality of particles.

9. The system of claim 1, wherein the media includes video having a plurality of frames, wherein the plurality of frames includes a first set of frames and a second set of frames, wherein the first set of frames includes representations of a first group of particles simulating a first concentration for a given type of particle, wherein the second set of frames includes representations of a second group of particles simulating a second concentration for the given concentration, and wherein the assessed function of the biological analyzer includes determining the first concentration for the given type of particle and the second concentration for the given type of particle.

10. The system of claim 1, wherein the media includes video having a plurality of frames, wherein the plurality of frames includes a first set of frames and a second set of frames, wherein the first set of frames includes representations of a first group of particles simulating a first plurality of concentrations for corresponding types of particles, wherein the second set of frames includes representations of a second group of particles simulating a second plurality of concentrations for the corresponding types of particles, and wherein the assessed function of the biological analyzer includes determining the first plurality of concentrations and the second plurality of concentrations.

11. A method for assessing a biological analyzer, comprising:
providing projecting media, the projecting media configured to project onto a projection region with a media source, wherein the media includes a representation of at least one particle within a flowcell;
capturing, with an imaging device aligned with the projection region, at least one image of the representation of the at least one particle; and
processing, with a processor, the at least one image of the representation of the at least one particle to assess a function of the biological analyzer.

12. The method of claim 11, further comprising controlling, with the processor, a motor to cause an objective lens of the imaging device to move a predetermined distance along an optical axis after determining that the representation of the at least one particle is in focus.

13. The method of claim 11, wherein the flowcell includes a viewing zone configured to receive fluid, and wherein the flowcell is configured to not cause a fluid flow through the viewing zone while the imaging device captures the at least one image of the representation of the at least one particle.

14. The method of claim 11, wherein the at least one particle comprises a control particle.

15. The method of claim 11, wherein the at least one particle comprises a calibration particle.

16. The method of claim 11, further comprising automatically adjusting, with the processor, an operation of the biological analyzer based on the assessed function of the biological analyzer.

17. The method of claim 11, wherein the at least one particle comprises a plurality of particles simulating a concentration for a given type of particle, and wherein the assessed function of the biological analyzer includes determining the concentration from the images of the plurality of particles.

18. The method of claim 11, wherein the at least one particle comprises a plurality of particles simulating a plurality of concentrations for a corresponding plurality of types of particle, and wherein the assessed function of the biological analyzer includes determining the plurality of concentrations from the images of the plurality of particles.

19. The method of claim 11, wherein the media includes video having a plurality of frames, wherein the plurality of frames includes a first set of frames and a second set of frames, wherein the first set of frames includes representations of a first group of particles simulating a first concentration for a given type of particle, wherein the second set of frames includes representations of a second group of particles simulating a second concentration for the given concentration, and wherein the assessed function of the biological analyzer includes determining the first concentration for the given type of particle and the second concentration for the given type of particle.

20. The method of claim 11, wherein the media includes video having a plurality of frames, wherein the plurality of frames includes a first set of frames and a second set of frames, wherein the first set of frames includes representations of a first group of particles simulating a first plurality of concentrations for corresponding types of particles, wherein the second set of frames includes representations of a second group of particles simulating a second plurality of concentrations for the corresponding types of particles, and wherein the assessed function of the biological analyzer includes determining the first plurality of concentrations and the second plurality of concentrations.
